(19) United States
(12) Patent Application Publication
(10) Pub. No.: US 2010/0295369 A1
(43) Pub. Date: Nov. 25, 2010

(54) POWER SUPPLY SYSTEM

(75) Inventors: TOMONORI HIRAI, Tu-Cheng (TW); JYHMING JONG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/507,517

(22) Filed: Jul. 22, 2009

(30) Foreign Application Priority Data
May 25, 2009 (CN) 200910302603.6

(51) Int. Cl. H02J 1/00; H02J 9/00; H02J 1/10

(52) U.S. Cl. 307/23; 307/66

(57) ABSTRACT

A power supply system includes a function unit, a power supply unit, a power distributing unit, and a capacitor. The power supply unit includes at least one first power supply module supplying voltage to the function unit and at least one second power supply module supply voltage to the function unit only when the at least one first power supply module is not supplying a voltage. The power distributing unit electrically couples the function unit with the power supply unit. The power supply unit is capable of supplying voltage to the function unit via the power distributing unit. The capacitor is electrically coupled to the function unit in parallel and capable of supplying voltage to the function unit when the power supply unit cannot supply the voltage to the function unit.

### BACKGROUND

1. Technical Field

The present disclosure relates to power supplies, and particularly to a power system with a plurality of power supply modules.

2. Description of Related Art

Usually, a power supply is needed to supply a stable voltage to an electronic device when the electronic device is at work. However, the power supply cannot supply the stable voltage when during a malfunction, which would result in abnormality of the electronic device in executing functions, or even damaging the electronic device.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a conventional power supply system, according to the prior art.

FIG. 2 is a bock diagram of an embodiment of a power system of the present disclosure.

### DETAILED DESCRIPTION

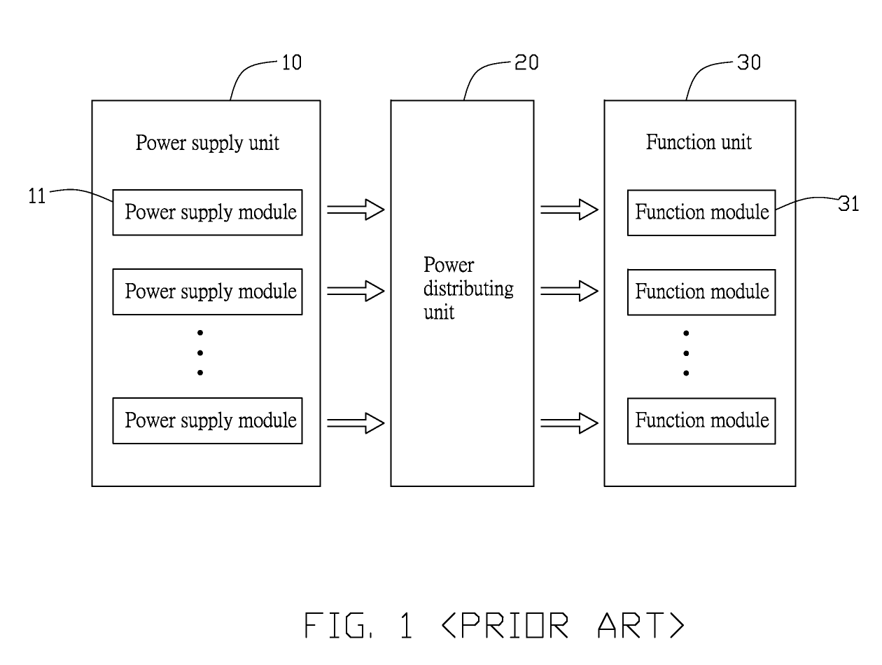

FIG. 1 illustrates a conventional power supply system, according to the prior art, which includes a power supply unit 10, a power distributing unit 20, and a function unit 30. The power supply unit 10 includes a plurality of power supply modules 11 coupled with each other in parallel. The power distributing unit 20, which may be cables or a circuit board, is capable of electrically coupling the power supply unit 10 with the function unit 30. The function unit 30 includes a plurality of function modules 31 electrically coupled with each other in parallel. Each of the function modules 31 may be an electronic component, such as a CPU, a disk drive, and so on, and requires a stable voltage to execute functions thereof.

Supposed that there are N+M power supply modules 11 in the power supply unit 10. The N power supply modules 11 are used to supply power to the function unit 30. The M power supply modules 11 are standby power supplies. When one or more of the N power supply modules 11 are depleted or malfunctioning so as unable to supply power to the function unit 30, one or all of the M power supply modules 11 would replace the one or more unworkable power supply modules 11 to supply power to the function unit 30.

However, there is a time period between when the one or more of the N power supply modules 11 discontinue and when the one or more of the M power supply modules 11 replace the one or more unworkable power supply modules 11. The time period maybe too long, because that the one or more of the M power supply modules 11 cannot replace the one or more unworkable power supply modules 11 to supply power to the function unit 30 in a timely manner. The power supply unit 10 would not be able to supply the stable required voltages to the function modules 31. This would result in abnormality of the function modules 31 in executing functions, or even damaging the function modules 31. So, it is very important to maintain the stable required voltage of the function modules 31 during the time period.

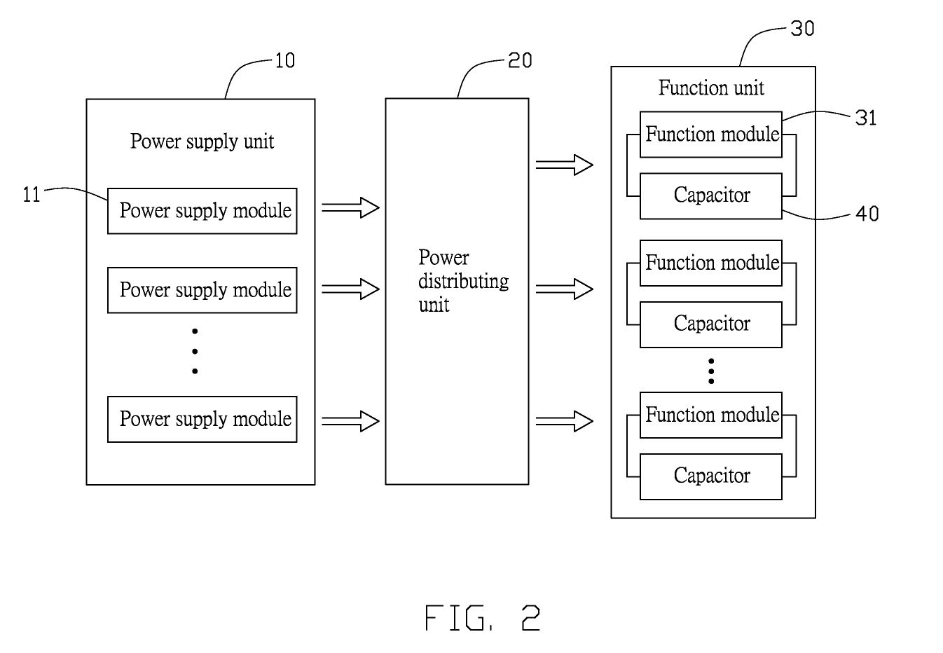

FIG. 2 illustrates an embodiment of a power supply system of the present disclosure that can overcome the above problem. The power supply system is similar to the conventional power supply system, and further comprises a plurality of capacitors 40. Each capacitor 40 electrically connects with one of the function modules 31 in parallel. The capacitors 40 are charged when the power supply unit 10 supplies power to the function unit 30, and discharges when the power supply unit 10 cannot supply the stable required voltage to the function unit 30 in the time period. In the time period, when the power supply unit 10 cannot supply the stable required voltage to the function unit 30, each capacitor 40 discharges to supply power to maintain the stable required voltage to the corresponding one function module 31, until the power supply unit 10 can supply the stable required voltage to the function unit 30 or the capacitor is fully discharged.

In the embodiment, the capacitors 40 can be traditional capacitors, such as an electrolytic capacitor and can discharge in a relatively quick time, to supply power to the function modules 31 once the function unit 10 cannot supply required voltages to the function modules 31.

In another embodiment, the capacitors 40 can be super capacitors, which can discharge in a less time than the traditional capacitors. The super capacitor is an electric double-layer capacitor, which is electrochemical capacitor having an unusually high energy density when compared to the traditional capacitor, typically on the order of thousands of times greater than a high capacity traditional capacitor. For instance, a typical D-cell sized traditional capacitor will have a capacitance in the range of tens millifarads. The same size super capacitor would have a capacitance of several farads, an improvement of about two or three orders of magnitude in capacitance, but usually at a lower working voltage.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A power supply system comprising:
a function unit comprising a plurality of function modules;
a power supply unit;
a power distributing unit electrically coupling the function modules with the power supply unit, wherein the power supply unit is capable of supplying voltages to the function modules via the power distributing unit; and
a plurality of capacitors, each of the capacitors electrically coupled to one of the function modules in parallel and capable of discharging to supply power to the corresponding one function module when the power supply unit fails to supply the required stable voltage to the corresponding function module.

2. The power supply system of claim 1, wherein the power supply unit comprises a plurality power supply modules capable of supplying power to the function unit; the power supply modules are electrically coupled to each other in parallel.

3. The power supply system of claim 2, wherein the power supply unit further comprises a plurality of standby power supply modules; one or more of the standby power supply modules is capable of supplying power to the function unit when one or more of the power supply modules is not supplying a voltage.

4. The power supply system of claim 1, wherein the capacitors are super capacitors.

5. The power supply system of claim 4, wherein the super capacitors are electric double-layer capacitor.

6. A power supply system comprising:
a function unit;
a power supply unit comprising at least one first power supply module supplying voltage to the function unit and at least one second power supply module supply voltage to the function unit only when the at least one first power supply module is not supplying a voltage; and
a power distributing unit, wherein the power supply unit is capable of supplying voltage to the function unit via the power distributing unit; and
a capacitor electrically coupled to the function unit in parallel, and capable of supplying voltage to the function unit when the power supply unit fails to supply the voltage to the function unit.

7. The power supply system of claim 6, wherein the at least one first power supply module is electrically coupled to the at least one second power supply module in parallel.

8. The power supply system of claim 6, wherein the capacitor is a super capacitor.

9. The power supply system of claim 8, wherein the super capacitor is an electric double-layer capacitor.
